(19) United States
(12) Patent Application Publication
(10) Pub. No.: US 2022/0092390 A1
(43) Pub. Date: Mar. 24, 2022

(54) SYSTEMS AND METHODS OF COMPONENT-BASED MODELING USING TRAINED SURROGATES

(71) Applicant: Julia Computing, Inc., Newton, MA (US)

(72) Inventors: Christopher RACKAUCKAS, Newton, MA (US); Viral B. SHAH, Newton, MA (US); Yingbo MA, Newton, MA (US)

(21) Appl. No.: 17/491,823

(22) Filed: Oct. 1, 2021

Related U.S. Application Data
(63) Continuation of application No. PCT/US21/50916, filed on Sep. 17, 2021.
(60) Provisional application No. 63/080,311, filed on Sep. 18, 2020.

(51) Int. Cl. G06N 3/04

(52) U.S. Cl. CPC G06N 3/0454

(57) ABSTRACT

Systems and methods of component-based modeling using trained surrogates are disclosed. A component architecture is made up of composable subsystem components. The composable subsystem components are reusable, such that the subsystem components are trained, and a library of trained model-reduced forms is created, which allows for large-scale models to be automatically accelerated for modeling. In this way, complex models are built by stitching together pre-designed, pre-shrunk components consisting of self-contained systems. A novel combination of using surrogates for modeling purposes and accelerated solving is provided to create an architecture that simulates complex physical processes that were previously infeasible to simulate in a commercially reasonable time.

### CROSS-REFERENCE TO RELATED APPLICATIONS

This application is a continuation application of PCT Application No. PCT/US21/50916 filed on Sep. 17, 2021 which claims priority to U.S. Provisional Patent Application No. 63/080,311 filed on Sep. 18, 2020, by Julia Computing, Inc., entitled “SYSTEMS AND METHODS OF COMPONENT-BASED MODELING USING TRAINED SURROGATES,” the entire contents of all of which are incorporated by reference herein.

### GOVERNMENT SUPPORT

This invention was made with U.S. Government support under ARPA-E Award No. DE-AR0001222, awarded by ARPA-E. The Government has certain rights in this invention.

### TECHNICAL FIELD

The field of the invention relates generally to methods and systems for component-based modeling and simulation of complex processes. More specifically, the field of invention relates to component-based models of composed systems using reusable trained surrogates.

### BACKGROUND

Complex physical problems in the real-world are often governed by systems of differential equations. Because of this, such physical problems require solving of differential equations to be effectively modeled, and such physical problems cannot be well represented in traditional neural-network libraries (e.g., TensorFlow or PyTorch) because traditional neural-network libraries are generally designed for use on images, language, or other big data that is not governed by physical processes.

In many cases, computer-based modeling of real-world physical processes is a time- and resource-intensive task where a simulation of the system takes so long to run that the resulting output of the simulation is not commercially valuable because the results are not readily available in a commercially viable timeframe. As one example, the present state-of-the-art in dynamic HVAC system simulation for a large commercial building is such that a simulation may occur approximately in real-time, meaning that 1 second of time in the simulation requires 1 second of computing time. Such an approximately-real-time simulation speed may be undesirable, for example, where decisions need to be made in the order of days, but the simulation may take on the order of months to complete.

Accordingly, there is a need for a methods and systems of modeling complex processes that significantly reduce the amount of processing time while providing for configurable and accurate results.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The methods and systems described herein solve the above-identified problems by providing component-based modeling that uses trained surrogates to replace components of a large, complex system with a trained surrogate approximation that is able to recreate the dynamics of the solution.

### BRIEF DESCRIPTION OF THE DRAWINGS

The present embodiments are illustrated by way of example and are not intended to be limited by the figures of the accompanying drawings.

FIG. 1 depicts an exemplary block diagram illustrating the generation of a library of trained surrogates to be used in the component-based modeling system.

FIG. 2 depicts an exemplary block diagram illustrating how a model of a complex system is built using trained surrogates to simulate the complex system.

FIG. 3 depicts an exemplary process flow of a method for generating a surrogate for the library that can be used in the component-based modeling system.

FIG. 4 depicts an exemplary process flow of a method for building and simulating a model using trained surrogates in the component-based modeling system.

FIG. 5 depicts the trained surrogates from the library being used in multiple different simulations without the need for retraining.

FIG. 6 depicts a prior-art diagram for an exemplary HVAC building system that has been used as a test case for modeling and simulation using previously known methods.

FIG. 7 depicts a pre-trained surrogate being used to represent a portion of the exemplary HVAC building system shown in FIG. 6.

FIG. 8 depicts an example of training a surrogate for the single air-conditioning unit.

FIG. 9 depicts a block diagram illustrating one embodiment of a computing device that implements the methods and systems for component-based modeling described herein.

### DETAILED DESCRIPTION

The following description and figures are illustrative and are not to be construed as limiting. Numerous specific details are described to provide a thorough understanding of the disclosure. In certain instances, however, well-known or conventional details are not described in order to avoid obscuring the description. References to “one embodiment” or “an embodiment” in the present disclosure may be (but are not necessarily) references to the same embodiment, and such references mean at least one of the embodiments.

The systems and methods of component-based modeling using trained surrogates described herein use a component architecture made up of composable subsystem components. The composable subsystem components are reusable trained surrogates. As used herein, component-based modeling refers to stitching together a large-scale causal or a causal model using trained surrogates. The composable subsystem components are reusable, such that the subsystem components (i.e., surrogates) have been trained, and a library of the trained surrogates is created, which allows for large-scale models to be built using the trained surrogates, and the trained surrogates provide for automatic acceleration of the model. In this way, complex models are built by stitching together pre-designed, pre-shrunk components consisting of self-contained systems. Thus, the systems and methods presented herein provide a novel combination of using trained surrogates for modeling purposes and accelerated differential-equation solving to create an architecture that can solve and/or simulate complex physical processes that were previously infeasible to solve in a commercially reasonable time.

The systems and methods of component-based modeling using trained surrogates described herein offer a practical application in that they provide a library of trained surrogates that can be used and reused by users without specialized experience in scientific computing. One advantage of the systems and methods of component-based modeling using trained surrogates described herein is that a high-fidelity simulation that would normally take approximately one month to be completed can now be completed in hours. In some embodiments, the systems and methods described herein may use GPU computing or distributed parallelism with the surrogates to compute the results even faster.

In some embodiments, neural or universal differential equations are used as surrogates for the components. These models are differential equations that have a learnable nonlinear function, such as a Gaussian process, radial basis function, polynomial basis functions (Chebyshev polynomials, Legendre polynomials, etc.), Fourier expansions, or a neural network. These function representations can be trained to predict accurate timeseries for the dynamics of a given component. In some embodiments, the system of differential equations that is learned is smaller than the original component, making it known as a nonlinear model order reduction.

In some embodiments, surrogates such as continuous or discrete time echo state networks, may be used to emulate the behavior of a component. Echo state networks are processes which simulate a dynamical reservoir process and learn a projection matrix to recover the dynamics. While this case may not result in a smaller system, this representation can be much more efficient to compute due to having numerical properties such as decreased stiffness.

In some embodiments, the direct computation of the timeseries outputs may be approximated by a surrogate such as a (physics-informed) neural network or radial basis function, providing a mesh-free representation of the time series which can be sampled as necessary within the composed simulation.

For ease of reference, and by way of non-limiting example, reference is made throughout this disclosure to the problem of accelerating coupled HVAC building simulation models. However, a person skilled in the art will understand that the principles disclosed herein likewise apply to modeling of any type of complex system or process.

HVAC systems for commercial and residential buildings are responsible for a significant portion of energy consumed nationally. Thus, energy conservation efforts tend to focus on improving the efficiency of individual systems for reasons of practical implementation. However, the benefits of this approach to achieving energy efficiency of the individual systems reach a point of diminishing returns because of the maximum technological limits of current HVAC technologies. As a result, systems-level approaches (rather than component-level approaches) to energy reduction have been used. These systems-level approaches include the use of variable-speed components for improved part-load system performance, customized equipment with such elements as economizers and evaporative cooling, and advanced controls incorporate optimization for improved system operation. For example, a Modelica-based solution has been developed to simulate HVAC systems in buildings; however, the component models describing system dynamics have different numerical properties than previous models. Whereas existing component models only capture the input/output behavior, models intended for use in control design necessarily expose a much richer range of dynamical behavior. These building-system level models thus evolve over a much wider range of time-scales, which results in stiffness of the set of differential equations and significantly slows the speed of the simulations. For example, a dynamic Modelica-based simulation of a commercial building with a variable refrigerant flow system and outdoor air system took two months to build and ran at the unacceptable rate of approximately real time: simulating a one month long interval takes one month on the computer. In short, the characteristics of the models outstrip the capabilities of the simulation. Engineers can create models that are too complex to be simulated. The complex interactions between active façades, high-efficiency ventilation systems, and heterogeneous collections of radiant and convective space conditioning systems under feedback control is a key aspect of improving the energy efficiency of buildings and maintaining reliability via the electrification of building systems as renewable sources become prevalent, but new tools are needed to enable engineers to quickly and accurately simulate and analyze the performance of these new systems.

The component-based modeling system using trained surrogates described herein, when applied to the building simulations described above, allows for an average HVAC-coupled building simulation to go from approximately real-time speed to at least 25 times faster, and in some cases, as much as 200 times faster.

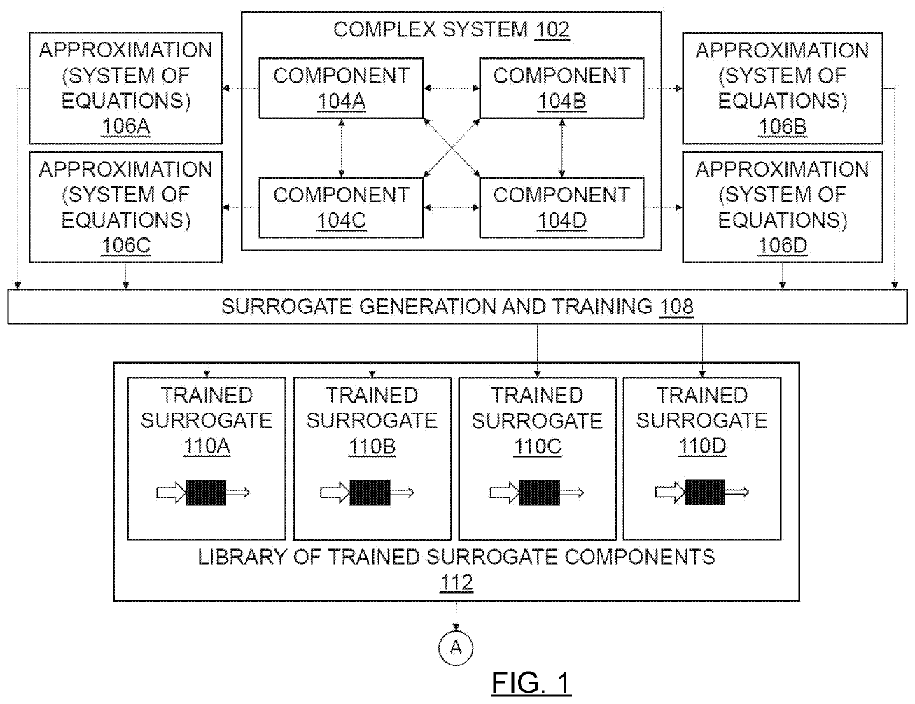

FIG. 1 depicts an exemplary block diagram illustrating the generation of a library of trained surrogates to be used in the component-based modeling system.

Referring to FIG. 1, complex system 102 may represent any real-world physical system or other system or process. Using the HVAC building system example described above for illustrative purposes, complex system 102 may represent the HVAC system of a commercial building. Complex system 102 comprises multiple components 104A-104D, some or all of which are interconnected to one another. The arrows between components 104A-104D represent interconnections between the components of the system. These interconnections between the components are such that some or all of the components interact with some or all of the other components, either through their inputs, their outputs, or both. Referring to the HVAC system example, the components may include an HVAC system, outside environmental factors, the floor plan/layout of the building, the controls of the HVAC system, and the like. Each of components 104A-104D may be approximated as a mathematical relationship comprising a system of equations. In one example, the system of equations may be a system of differential-algebraic equations (“DAEs”). Thus, approximations 106A-106D are mathematical equations that describe the behavior of the respective components 104A-104D. In some examples, the approximations 106A-106D are represented by DAEs.

Surrogates representing approximations 106A-106D are generated and trained as part of surrogate generation and training 108. In one embodiment, surrogate generation and training 108 may use model-order reduction to reduce the approximations 106A-106D into systems of fewer differential equations that reproduce the dynamics on specific observables. In other embodiments, surrogate generation and training 108 may generate surrogates of the same or larger system size as the approximations that still provide accelerated modeling of the approximations. In various embodiments, the surrogate generation and training 108 may be performed by one or more of the methods described above.

In some embodiments, the composed modeling platform may supply prebuilt routines for generating surrogates from components defined in the language or API of the system.

In some embodiments, the generation of the pre-trained library can be done by a third-party that trains and ships the components as part of the library. In other embodiments, this can be done by individual users with pre-specified or custom surrogates and training regimes provided by the component-based modeling library system or third-party additions.

The surrogates that are generated and trained represent small components that can be pieced together for the full-form model. In some embodiments, a small nonlinear approximation is trained to a larger model. In the context of differential equations, a large complex system of differential equations is replaced with a small nonlinear approximation (i.e., surrogate) that recreates the dynamics of the component being modeled.

The component-based modeling tools described herein automate the generation and training of surrogates to reduce the components, which allows the library to deploy trained surrogates for users to use as building blocks for larger, complex systems. In some embodiments, users of these systems thus may not need to perform any training themselves because their system can be adequately described by the composition of these pre-trained surrogates. Thus, in many instances, the surrogates may provide pre-accelerated components that allow for much faster modeling than modeling in which each component is trained each time the component is used.

The surrogate generation and training 108 of the approximations 106A-106D generates trained surrogates 110A-110D, respectively. Each trained surrogate 110A-11D is a nonlinear approximation to a component that has been trained. As shown in FIG. 1, trained surrogates 110A-110D represent black-box components where, once trained, the input is transformed into an output that matches the behavior of the original system. In one embodiment, the trained surrogates 110A-110D are comprised of neural networks.

Trained surrogates 110A-110D can be used as these approximations to generate a full model of complex system 102. One key innovative aspect of the component-based modeling system using trained surrogates described herein is that the trained surrogates may be reused in multiple different systems and shipped to be used by other individuals once they have been trained. In one embodiment, the trained surrogates may be used by the same user (or group of users) who trained the surrogate. In such an embodiment, the user may generate and train the surrogate and then deploy that surrogate by using it in a model. In other embodiments, the trained surrogates may be used by a different user than the user who trained the surrogate. In such an embodiment, the trained surrogate or the entire library of trained surrogates (or just a subset of the entire library) may be provided to one or more users who are unrelated to the user who trained the surrogate. In this way, once the surrogates are generated and trained, they may be stored and then either sent to or accessed by users who will use them in a model.

Each trained surrogate may represent a particular component in a system, as shown in FIG. 1, or the trained surrogates may represent a combination of multiple components in the system. In other words, trained surrogates may be generated for different levels of abstraction within the system.

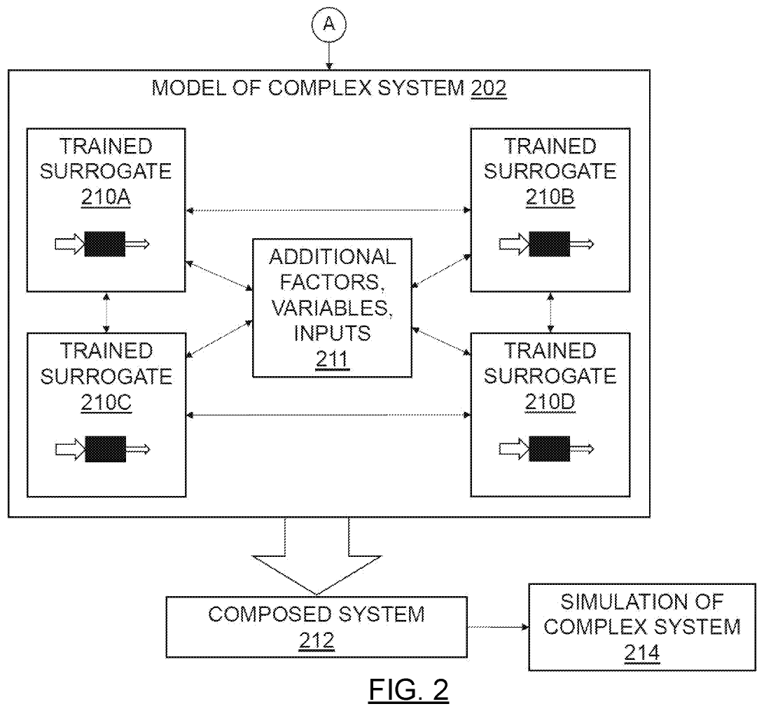

Trained surrogates 110A-110D are stored (once they have been trained) in a library of trained surrogate components 112. In one embodiment, the trained surrogates 110A-110D are stored for later use. The trained surrogates 110A-110D stored in the library of trained surrogate components 112 are used as components to build various types of models (as represented by continuation bubble “A” in FIG. 1, which leads to FIG. 2). Once the trained surrogates have been generated, trained, and stored in the library, they are then available to be used in any other system that a user is building.

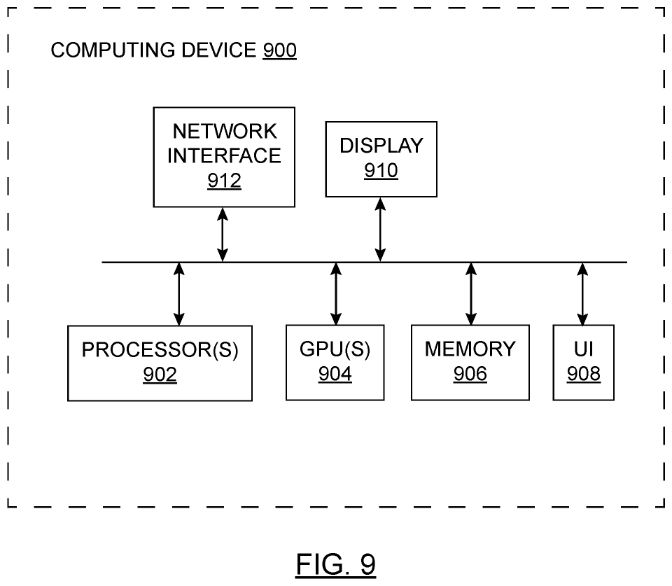

The library of trained surrogate components 112 may be stored locally on a user's computer, or they may be stored on a server (e.g., a cloud-based server or a network server). An example of such a computing device is shown in FIG. 9. Part or all of the entire library of trained surrogate components 112 may be accessible remotely to other users. For example, users may be able to access and download the library from the server, or the library may be downloaded by or shipped or transferred to users via a GUI or other software that accesses the server.

For the purposes of this disclosure, the process of generating and training a surrogate includes situations where the training and generation of the surrogate occurs before the deployment and/or use of the trained surrogate in a model, as well as situations where the training and generation of the surrogate occurs approximately at the same time as, or immediately before, the deployment and/or use of the surrogate in a model. In other words, a surrogate may be generated and trained and then immediately (or nearly immediately) deployed and/or used in a model. This may be referred to as just-in-time surrogate generation and training. Such a situation would still be considered generating and training the surrogate because, even though it is immediately deployed, it is still available to be used in other models later as well.

By using trained surrogates in place of complex components, a system represented by thousands of equations may be condensed down and represented by a handful of equations. For example, if an HVAC system is represented by approximately 8,000 equations to correctly model it, the trained surrogates can allow the important inputs and observables of the HVAC system to be represented by approximately 20 equations. The 20-equation representation is then stored for future use (as a trained surrogate) such that it can be reused in another system without having to again reduce the system of equations from the approximately 8,000 equations to the approximately 20 equations.

In some embodiments, the trained surrogates may be trained differently, for example, to different levels of fidelity, based on the type of system or processor that will run the simulation. For example, a much higher level of fidelity may be used when generating the trained surrogates to be used in model to be run on a GPU or a supercomputer, in contrast to a lower level of fidelity when generating the trained surrogates to be used in a model to be run in an embedded system or other system with relatively minimal processing power, for example, a smart watch or an Internet-of-Things (“IoT”) device. The level of fidelity represents how accurately the output of the trained surrogate tracks or matches the output of the system being modeled.

FIG. 2 depicts an exemplary block diagram illustrating how a model of a complex system is built using trained surrogates to simulate the complex system.

Referring to FIG. 2, a full model of a complex system 202 may be built using the trained surrogates stored in the library (as represented by continuation bubble “A”). For example, trained surrogates that were generated and trained as explained in the context of FIG. 1 may then be used in a plug-and-play manner to build and model a complex system. Trained surrogates 210A-210D may be selected by a user to build a representation of the complex system. A user may further add additional factors, variables, and/or inputs 211 that are included in model 202. A user may specify interconnections between the neural components. The interconnections are shown as double-headed arrows in model 202 of FIG. 2. The interconnections represent input and/or output relationships between the components. From the model 202, a composed system 212 is generated based on the combination of the trained surrogates 210A-210D, the additional factors, variables, and inputs 211, and the interconnections between them. In some embodiments, the composed system 212 is a system of differential-algebraic equations or ordinary differential equations. In some embodiments, the set of equations that comprise the composed system 212 may be larger than the original set of equations defining the system being modeled. Such a scenario still provides an advantage in the simulation because it may give more accurate results than other reduced composed systems, but because the system is built using trained surrogates, the surrogates provide for faster simulation since they are pre-trained (e.g., pre-accelerated). The composed system 212 is accomplished by flattening the representation to build the complete description of the model with the components, including the surrogates, embedded within. In some embodiments, the composed system generation may utilize the structure of the system to computationally allow reuse of the same surrogate in multiple different locations for increased efficiency. From the composed system 212, the simulation of the complex system 214 is performed. Because of the trained surrogates embedded within this generated model, the simulation of the system runs much more quickly than a simulation of the actual system being modeled.

As explained above, in some embodiments, this library may be immediately used to build a composed model locally by the individual who developed the surrogates as soon as the surrogates have been trained. In other embodiments, this library can be sent or supplied to other remote users who utilize the components within their own composed systems (e.g., by accessing the library via a server). These use cases are not mutually exclusive.

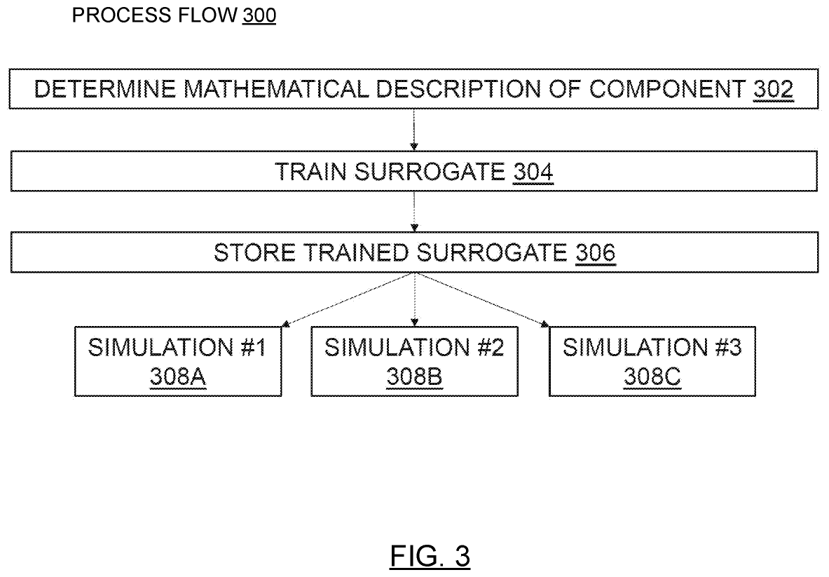

FIG. 3 depicts an exemplary process flow of a method for generating a surrogate for the library that can be used in the component-based modeling system. The method described in the context of FIG. 3 may be implemented by at least one processor or other circuitry in a computing device such as the exemplary computing device shown in FIG. 9 or a system comprising one or more computing devices such as the exemplary device shown in FIG. 9.

Referring to FIG. 3, a mathematical description of a component is generated at step 302. The mathematical description of the component may be a system of equations. In some examples, the system of equations may be a system of differential-algebraic equations. The mathematical description may be generated by direct description from modelers with domain expertise or by composing previously written components. At step 304, training of a surrogate is performed on the mathematical description of the component to create a surrogate that provides an accurate representation of the mathematical description (e.g., DAE or other type of system of equations). In some embodiments, the trained surrogate may be a neural network. At step 306, the trained surrogate is stored in a library such that the trained surrogate is available for use to build a model. Each trained surrogate may be used and reused in multiple different simulations without the need to retrain the surrogates, for example in simulation #1 308A, simulation #2 308B, and/or simulation #3 308C.

In some embodiments, the mathematical description of the component may be generated as an approximation comprising a system of equations. The approximation represents a physical process of a component of a system. In some examples, the system of equations for the approximation may be a system of differential-algebraic equations. The approximation may be generated by direct description from modelers with domain expertise or by composing previously written components. In these embodiments, training of a surrogate is performed on the approximation to create a surrogate that provides an accurate representation of the approximation (e.g., DAE or other type of system of equations). In some embodiments, the trained surrogate may be a neural network. The trained surrogate is stored in a library such that the trained surrogate is available for use to build a model. Each trained surrogate may be used and reused in multiple different simulations without the need to retrain the surrogates, for example in simulation #1 308A, simulation #2 308B, and/or simulation #3 308C.

In some embodiments, the mathematical description or approximation may be generated based on input received from a user via a graphical user interface (GUI). For example, the user may use the GUI to build the approximation by defining the characteristics of the approximation in the GUI. This may include, for example, entering mathematical relationships.

In some embodiments, the surrogate may be trained based on input received from the user via the GUI. For example, the user may use the GUI to define training parameters for the surrogate.

In some embodiments, the trained surrogate may be stored based on input received from the user via the GUI. For example, the user may use the GUI to specify the format for saving the trained surrogate or where to save the trained surrogate.

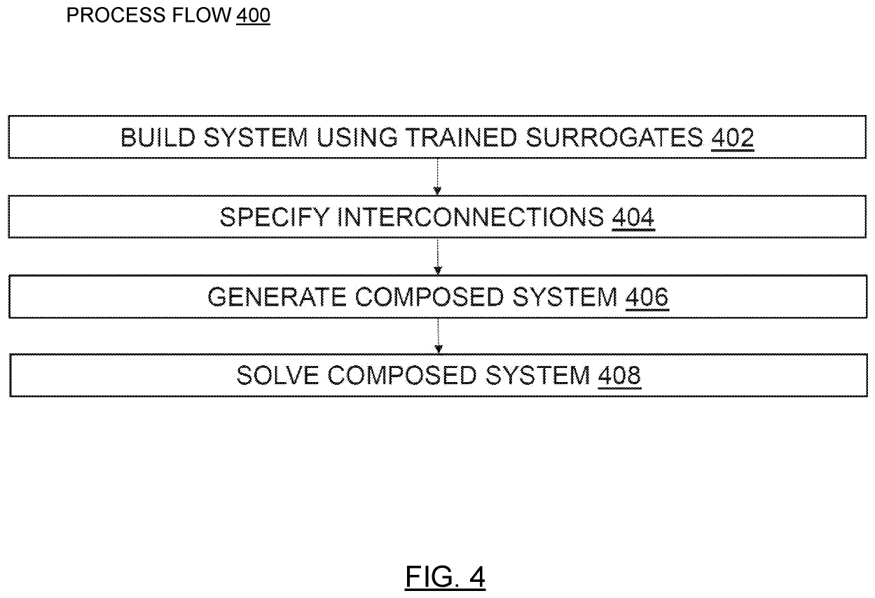

FIG. 4 depicts an exemplary process flow of a method for building and simulating a model using trained surrogates in the component-based modeling system. The method described in the context of FIG. 4 may be implemented by at least one processor or other circuitry in a computing device such as the exemplary computing device shown in FIG. 9 or a system comprising one or more computing devices such as the exemplary device shown in FIG. 9.

Referring to FIG. 4, at step 402, a system is built using trained surrogates. The trained surrogates do not need to be retrained before being used. A user may build the system by selecting one or more trained surrogates to represent physical processes or other processes or factors. At step 404, interconnections between one or more of the neural components are specified. The interconnections may also include additional inputs, factors, or other variables that operate on the system in addition to the surrogates. At step 406, a composed system is generated to represent the system of the trained surrogates. At step 408, the composed system is solved.

In some embodiments, a user of the component-based modeling system using trained surrogates described herein uses a graphical user interface (GUI) to describe the composition for the library of pre-trained surrogates. The GUI provides for easy surrogate training (e.g., “one-click” surrogate generation) such that the user may select one or more portions of a system via the GUI, and those one or more portions of the system will be used to generate and train a surrogate using the training methods described herein. Similarly, the GUI provides easy access (e.g., plug-and-play) to trained surrogates stored in the library (either locally on the user's computer, remotely at another user's computer, remotely at a server, or any combination thereof) such that the user may locate a particular trained surrogate of interest and add it to the model they are building. Thus, one advantage of this system is that the user need not have any knowledge of the surrogate training process, nor do they need any knowledge of neural differential equations or programming to use the system to solve a particular problem. The system described herein provides readily accessible trained surrogates via the GUI, which accesses the library.

The component-based modeling system using trained surrogates described herein may be run on any type of computing device, whether a desktop computer, laptop computer, client device, networked workstation, or the like. An example of such a computing device is shown in FIG. 9. The computing device may include one or more processors and/or GPUs that process the operations, such as, for example, building the models, training the surrogates, storing the surrogates in the library, running the simulations and models, and handling network communication of the surrogates. The computing device may further include other circuitry that processes the operations, such as, for example, building the models, training the surrogates, storing the surrogates in the library, running the simulations and models, and handling network communication of the surrogates.

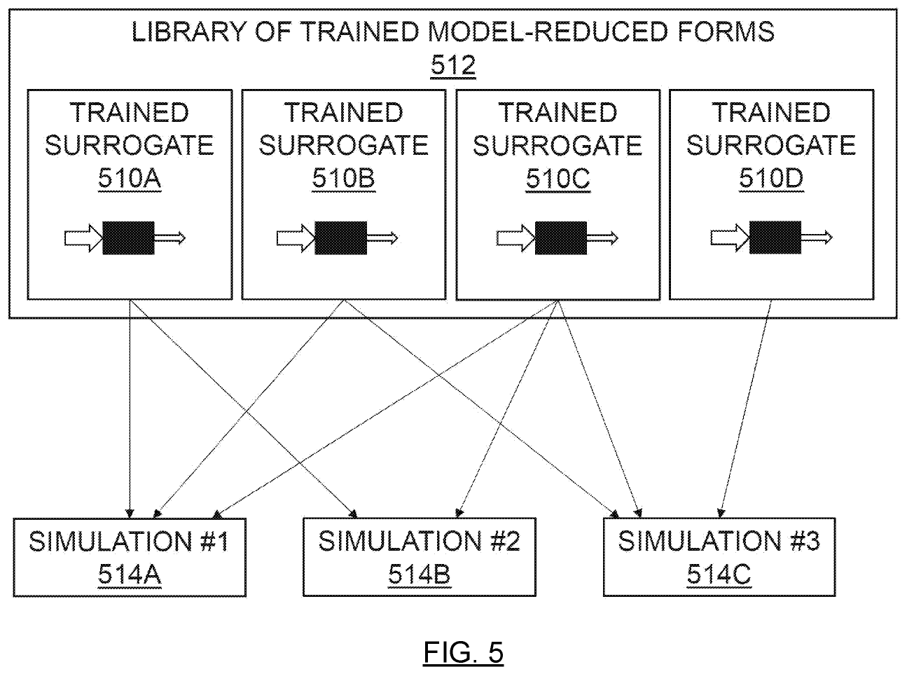

FIG. 5 depicts the trained surrogates from the library being used in multiple different simulations without the need for retraining.

Referring to FIG. 5, each of trained surrogates 510A-510D may be used in one or more simulations 514A-514C. As an illustrative example, trained surrogates 510A, 510B, and 510C may be used in simulation #1 514A, while trained surrogates 510A and 510C may be used in simulation #2 514B, and trained surrogates 510B, 510C, and 510D may be used in simulation #3 514C. Each of simulation #1-#3 may be completely different simulations with different goals and/or different systems being modeled. The trained surrogates 510A-510D may be reused in multiple systems without the need to rebuild or retrain the surrogates.

The component-based modeling system described herein uses high-performance differential equation solvers for physical systems, which provide automatic high-performance neural differential equation solving and training. The differential-equation solvers described herein support ordinary differential equations (ODEs), stochastic differential equations (SDEs), differential-algebraic equations (DAEs), delay differential equations (DDEs), and the like with high order, adaptive, implicit, and GPU-accelerated methods. In one embodiment, the high-performance neural differential equation training uses the DiffEqFlux.jl package from the Julia package ecosystem.

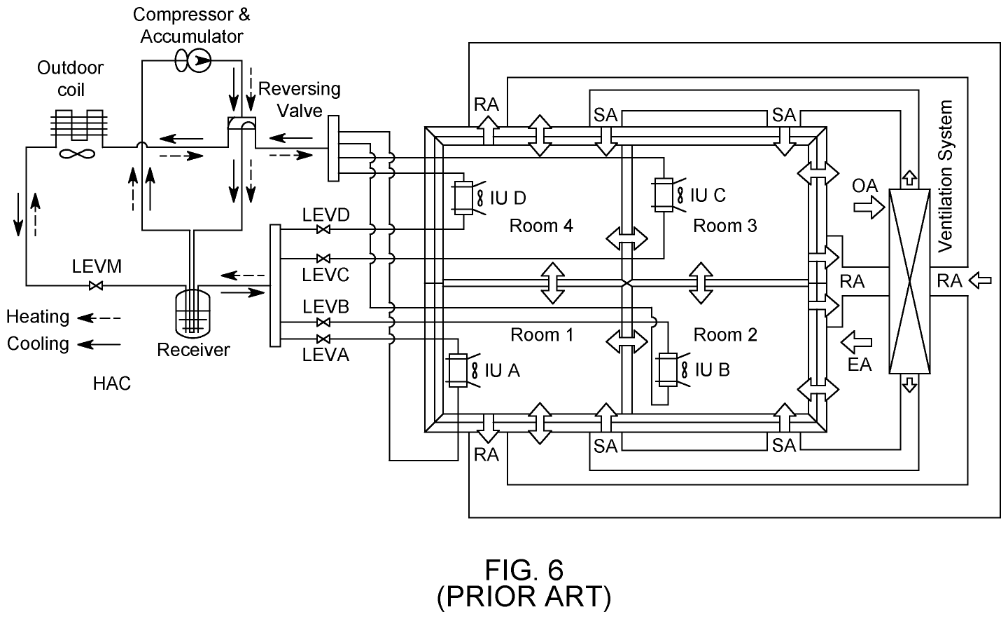

FIG. 6 depicts a prior-art diagram for an exemplary HVAC building system that has been used as a test case for modeling and simulation using previously known methods.

Referring to FIG. 6, traditional modeling of the system shown in FIG. 6 has a slow running time, meaning that the simulations have to be run over multiple days, which makes it impractical for standard use where such decisions are usually made within one to two days. The component-based modeling system with trained surrogates described herein provides a significant performance boost over the traditional modeling process, allowing it to be used as part of a standard building design and evaluation process.

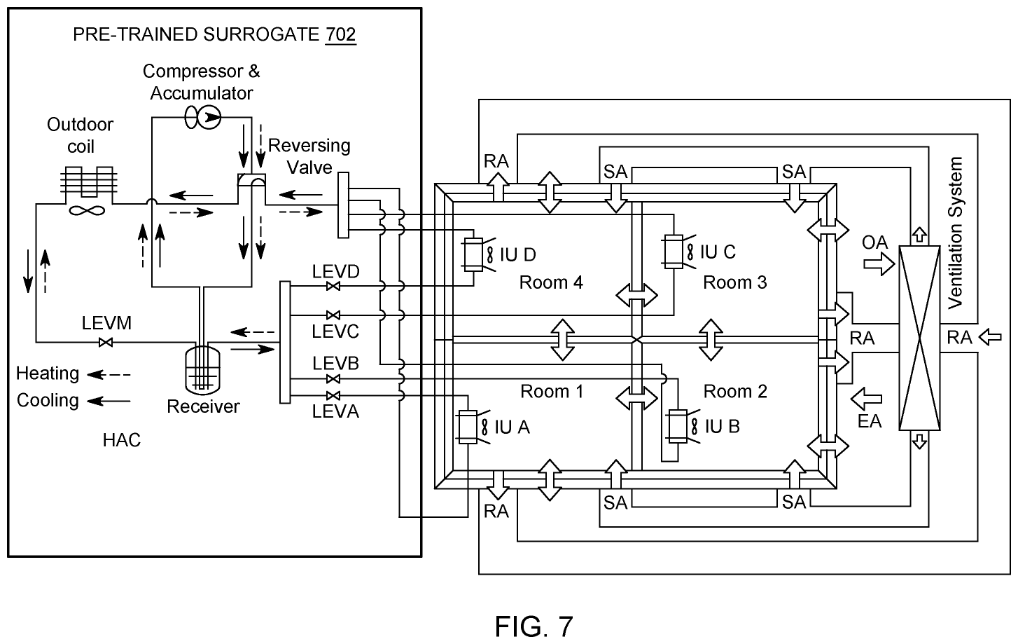

FIG. 7 depicts a pre-trained surrogate being used to represent a portion of the exemplary HVAC building system shown in FIG. 6.

Referring to FIG. 7, a pre-trained surrogate 702 may be used to represent an air-conditioning unit, as shown in FIG. 7. The pre-trained surrogate 702 provides an accelerated model for an air-conditioning unit that may be used in a model that includes an air-conditioning unit. Thus, for example, once the surrogate 702 for a single air-conditioning unit has been trained, the trained surrogate may be provided to users, either locally or via transmission over a network, to then use to build various building models. The various building models may have varying numbers of air-conditioning units in them. For example, one building may have nine air-conditioning units, so that building model would include nine accelerated air-conditioning units (i.e., trained surrogates 702). This trained-surrogate approach provides benefits in that the users do not have to know or understand machine-leaning to use or benefit from the component-based modeling system, and the initial training time of the surrogates does not factor into research time for a user.

As an example, a single air-conditioning unit may be represented by approximately 9,000 equations. For example, a vapor compression cycle model in an air conditioner includes component sub-models for a heat exchanger, a compressor, and an expansion valve. Additionally, thermodynamic refrigerant property models are also used to model the relationship between pressure, temperature, density, and the like. Physics-based component models are parametrized by geometric parameters and measurement data to provide good predictive performance. The dynamics of the air-conditioning unit are dominated by heat exchangers because they have a finite volume in a staggered-grid approximation. The compressor and valve models are algebraic.

As explained above, prior-art systems that use machine-learning acceleration via surrogates require retraining as the problem being solved changes. In contrast, the component-based modeling system using trained surrogated described herein accelerates differential-algebraic equation models without retraining. Multiple components in a library of components are pre-trained to be accelerated by surrogate techniques to match the input/output behavior on a chosen set of observables. The pre-trained accelerated components are then placed into larger models to accelerate user models. In some cases, the surrogates may have repeated use within a composed model.

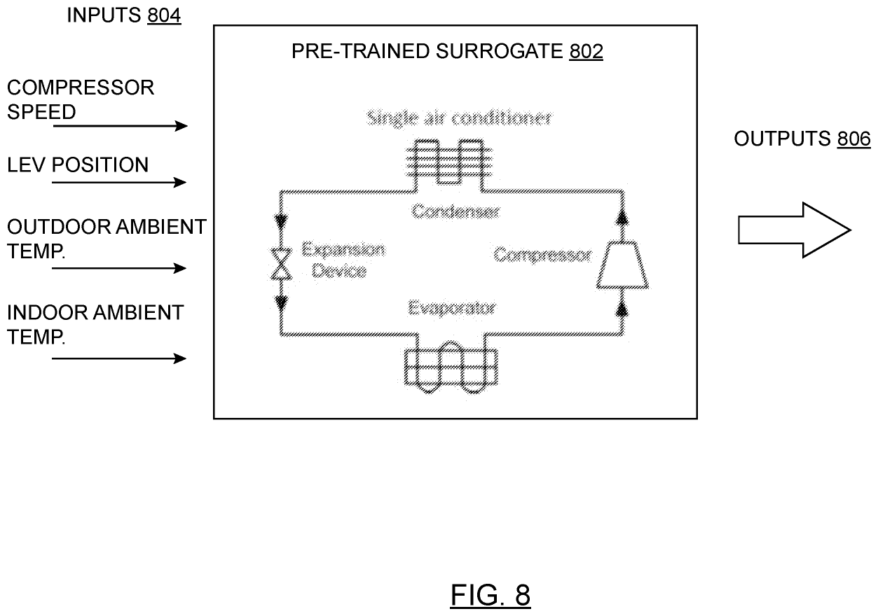

FIG. 8 depicts an example of training a surrogate for the single air-conditioning unit.

As can be seen in FIG. 8, a complex single air-conditioning unit may be represented by a surrogate 802 that takes only four inputs 804 (e.g., compressor speed, LEV position, outdoor ambient temperature, and indoor ambient temperature) and provides 16 outputs 806 that approximate the behavior of the single air-conditioning unit. As mentioned above, the complex interactions occurring within the air-conditioning unit may be represented by approximately 9,000 equations. The surrogate 802 provides an input/output signature from the input 804 of the surrogate 802 to the output 806 of the surrogate 802 that approximates those 9,000 equations.

In the component-based modeling system using trained surrogates described herein, scaling modeling complexity is accomplished using modularity. Thus, complex equation models are built by stitching together pre-designed components. The pre-designed components are self-contained differential equation systems that specify the interactions within a single component.

FIG. 9 depicts a block diagram illustrating one embodiment of a computing device that implements the methods and systems for component-based modeling described herein. Referring to FIG. 9, the computing device 900 may include at least one processor 902, at least one graphical processing unit (“GPU”) 904, a memory 906, a user interface (“UI”) 908, a display 910, and a network interface 912. The memory 906 may be partially integrated with the processor(s) 902 and/or the GPU(s) 904. The UI 908 may include a keyboard and a mouse. The display 910 and the UI 908 may provide any of the GUIs in the embodiments of this disclosure.

Returning to the HVAC example, once a detailed model for a specific HVAC component exists and a model for a building design has been built, a user may build a system that includes both of these models by declaring that the composite differential equation system would be composed of those two components. To do this in the component-based modeling framework described herein, a user only needs to state that there are N number of HVAC components, add their locations by equalities, and relate the states between components. The component-based modeling framework builds the composed differential-algebraic equation (DAE) or the ordinary differential equation (ODE) of the full model. These equalities make the resulting system be a DAE that can be automatically reduced to a mass matrix stiff ODE that can be solved using current numerical-solution techniques.

Thus, in the HVAC building example referred to herein, the component-based modeling system uses N number of pre-trained accelerated HVAC components to build up a substantially smaller building model that is accurate, which provides vastly reduced simulation times to allow for comprehensive hypothesis testing. One advantage of this approach is that the reduced surrogate approximation is not restricted to a single composite model, which allows for a surrogate component to be trained a single time and then that trained surrogate can be used to accelerate the evaluation of multiple proposed building designs.

This is accomplished using a newly developed compiler architecture that allows for automated symbolic reductions using a rewrite system based on symbolic computing algorithms. The compiler architecture allows for composing using surrogate libraries and/or neural differential equation solvers, and it allows for directly building differentiable functions that can be used with the automated differentiation libraries for performing training.

In one embodiment, the compiler architecture is the Julia ModelingToolkit.jl package. This package is able to compose components by representing the generated differential-algebraic equation and performing index reduction via algorithms like the Pantelides algorithm, which results in specifications that are compatible with numerical solvers for ODEs and DAEs.

Applications of the Component-Based Modeling Using Trained Surrogates

In addition to the exemplary HVAC system described herein, there are a number of other applications where the principles of the component-based modeling using trained surrogates described herein may be applied.

As a first example, the component-based modeling using trained surrogates described may be used for modeling of physiologically-based pharmacokinetics (PBPK) and quantitative systems pharmacology (QSP). This may be used to model various aspects of the human body, such as the lungs, heart, vascular system, organ systems, etc. In some embodiments, these models are used to analyze the overall effect of a drug on the system, including prediction of on-target effects and potentially toxic side effects. In some embodiments, these consist of ordinary differential equations, differential-algebraic equations, stochastic differential equations, delay differential equations, partial differential equations, or continuous-time Markov chains (also known as Gillespie simulations) for the components and/or the composed model.

As a second example, the component-based modeling using trained surrogates described herein may be used for modeling of automotive systems. This may be used to model various component systems of an automobile, such as the engine, the transmission, the entire powertrain, the exhaust system, the air-conditioning system, etc. In some embodiments, these models are used to measure the energy efficiency and safety of the design.

As a third example, the component-based modeling using trained surrogates described herein may be used for modeling of power-system dynamics, for example, for smart-grids for cities or other physical areas. This may be used to model power-generation, the grid designs themselves, and power usage of various components within the system. In some embodiments, these models are used to ascertain the effectiveness of automated control strategies.

As a fourth example, the component-based modeling using trained surrogates described herein may be used for modeling of battery systems. This may be used to model input/output relationships between an anode and a cathode of a battery, as well as the nearby heat flow within the battery and outside the battery. In some embodiments, these model are used to determine the energy storage capacity, the efficiency, and predict the degradation of the battery over time.

As a fifth example, the component-based modeling using trained surrogates described herein may be used for modeling of semiconductors. This may be used to model the specific submodules of the semiconductor, such as arithmetic logic units, temperature controls, balancing controls, and averaging controls, and determine the effectiveness of a composed semiconductor design.

As a sixth example, the component-based modeling using trained surrogates described herein may be used for the modeling of multiphysics on spatial designs and materials. In some embodiments, these may be discretizations of partial differential equations using methods like finite difference, finite volume, or finite elements, where components may correspond to physical components like the wing of an aircraft. This may be used to determine the effectiveness, in terms of quantities like energy efficiency and cost, of given product designs or perform topology optimization.

As a seventh example, the component-based modeling using trained surrogates described herein may be used for modeling the dynamics of chemical structures. In some embodiments, this may take the form of agent-based models, molecular dynamics, density functional theory, or quantum mechanical based dynamical models wherein the composed system is determined from the composition of chosen molecular components. This may be used to determine the effectiveness of given materials designs, both in organic and inorganic materials. In some embodiments this is used to determine the effectiveness of biofuel pathways using structural systems biology models.

As an eighth example, the component-based modeling using trained surrogates described herein may be used for modeling the dynamics of chemical reaction networks. In some embodiments this is used to determine the dynamics of chemical combustion given a combination of molecules. In other embodiments this is used to determine materials properties via microkinetic models. In other embodiments this is used to determine properties of biological dynamics, such as cell signaling pathways and the population dynamics. In these cases, the components may consist of submodules structurally or physically common between different cases of interest, such as a shared reaction pathway.

A person having ordinary skill in the art will recognize that the principles described herein may be applied to other physical systems not explicitly described herein, as the model described herein here provides a framework that is not specific to any particular physical system but rather can be used to build surrogates that represent components of any physical system.

The descriptions of the various embodiments of the technology disclosed herein have been presented for purposes of illustration, but these descriptions are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-84. (canceled)

85. A method of generating a surrogate for a library to be used in component-based modeling in scientific computing, the method comprising:
generating an approximation comprising a system of equations, wherein the approximation represents a physical process of a component of a system to be modeled;
training a surrogate based on the approximation; and
storing the trained surrogate for later use.

86. The method of claim 85, wherein the approximation is generated based on input received from a user via a graphical user interface (GUI), the surrogate is trained based on input received from the user via the GUI, and the trained surrogate is stored based on input received from the user via the GUI.

87. The method of claim 85, wherein the trained surrogate is stored in a library of trained surrogate components.

88. The method of claim 85, wherein the trained surrogate is a nonlinear reduced approximation of the component of the system to be modeled.

89. The method of claim 85, wherein the surrogate is a neural network.

90. The method of claim 85, wherein the system of equations is a system of differential-algebraic equations.

91. The method of claim 85, wherein the trained surrogate recreates the dynamics of the physical process of the system to be modeled.

92. The method of claim 85, wherein the trained surrogate is configured to be used as a representation of a physical process in a second system to be modeled that represents a second physical process.

93. The method of claim 85, wherein the trained surrogate is configured to be used in multiple simulations without retraining the trained surrogate.

94. The method of claim 85, wherein the trained surrogate is configured to be combined with other trained surrogates to build a composed system that can be solved using a differential-equation solver.

95. A system for generating a surrogate for a library to be used in component-based modeling in scientific computing, the system having at least one processor configured for:
generating an approximation comprising a system of equations, wherein the approximation represents a physical process of a component of a system to be modeled;
training a surrogate based on the approximation; and
storing the trained surrogate for later use.

96. The system of claim 95, wherein the approximation is generated based on input received from a user via a graphical user interface (GUI), the surrogate is trained based on input received from the user via the GUI, and the trained surrogate is stored based on input received from the user via the GUI.

97. The system of claim 95, wherein the trained surrogate is stored in a library of trained surrogate components.

98. The system of claim 95, wherein the trained surrogate is a nonlinear reduced approximation of the component of the system to be modeled.

99. The system of claim 95, wherein the surrogate is a neural network.

100. The system of claim 95, wherein the system of equations is a system of differential-algebraic equations.

101. The system of claim 95, wherein the trained surrogate recreates the dynamics of the physical process of the system to be modeled.

102. The system of claim 95, wherein the trained surrogate is configured to be used as a representation of a physical process in a second system to be modeled that represents a second physical process.

103. The system of claim 95, wherein the trained surrogate is configured to be used in multiple simulations without retraining the trained surrogate.

104. The system of claim 95, wherein the trained surrogate is configured to be combined with other trained surrogates to build a composed system that can be solved using a differential-equation solver.
